(19) United States
(12) Patent Application Publication
(10) Pub. No.: US 2023/0401041 A1
(43) Pub. Date: Dec. 14, 2023

(54) SYSTEM AND APPARATUS FOR AUTHORING AND DEVELOPING AUTOMATION INTERFACES AND PROCESSES WITHOUT WRITING CODE

(71) Applicant: Full Speed Automation, Inc., Los Gatos, CA (US)

(72) Inventor: Luc Leroy, Los Gatos, CA (US)

(21) Appl. No.: 18/250,102

(22) PCT Filed: Oct. 21, 2021
(86) PCT No.: PCT/US21/55966

§ 371 Date: Apr. 21, 2023

Related U.S. Application Data
(60) Provisional application No. 63/094,869, filed on Oct. 21, 2020.

(51) Int. Cl. G06F 8/34

(52) U.S. Cl. CPC G06F 8/34

(57) ABSTRACT

An integrated development environment or plugin thereto includes a source code generation module configured to automatically generate source code to expose commands for automation controls components. A graphical user interface has visual components that represent automation controls components to be interfaced with one another, and which are linked to the source code generation module. The integrated development environment enables modification of the component interfaces so that a plurality of event handlers can be implemented without having to write or edit any source code. The instantiation of a component into a project using the integrated development environment automates the generation of the source code that captures and broadcasts signals from the component to a communication channel that is declared on demand through the interface. A web application automatically creates the graphs or tables to represent the telemetry data for each signal received from the controller.

### CROSS REFERENCE TO RELATED APPLICATIONS

This application is the National phase under 35 U.S.C. § 371 of International Application No. PCT/US2021/55966, filed Oct. 21, 2021, which claims priority to U.S. Provisional Application No. 63/094,869 filed on Oct. 21, 2020. The entire contents of these patent applications are hereby incorporated by reference herein.

### TECHNICAL FIELD

The present invention generally relates to automation controls technology and specifically to a system for authoring and developing automation interfaces and processes without the need to write code.

### BACKGROUND ART

Since the introduction of programmable logic controllers in the field of automation controls, the capabilities of computers have greatly improved, with faster microprocessors allowing greater compute, larger and faster memory enabling the execution of larger and more complex programs that manipulate larger amounts of data. Network interconnectivity has also dramatically improved and components that used to be connected to programmable logic controllers (PLC), such as the early Allen Bradley PLC, via direct wires driving analog signals are now often communicating with the logic controller over Ethernet or similar network protocols. Over time, programmable logic computers have grown into computers to such an extent that nowadays popular programmable logic controllers use electronics similar to personal computers such as a computer system based on an Intel processor and are capable of running an operating system designed for personal computers, professional workstations and servers such as Microsoft Windows, different distributions of Linux or similar operating systems. Popular examples of such modern programmable logic controllers are the Siemens SIMATIC or the Beckhoff CX families of controllers.

Requirements and practices in the field of manufacturing have similarly evolved. Modeling tools have allowed the complexity of equipment, manufacturing lines and factories to grow significantly. It is not uncommon to observe hundreds of devices—from basic sensors to sophisticated industrial robots, connected to a single controller. The frequency and amount of data transferred across controllers and components has followed the same trend. Hundreds of megabytes of data transferred per second with latencies measured in milliseconds and sometimes microseconds for specialized controllers is a common trade. Data related to material flow, supply chain, product quality, human resources and a myriad of other fields are now part of the data manipulated by controllers and manufacturing execution systems.

Human-machine interfaces have historically been discrete from and connected to the programmable logic controller. More recently, following the increasing connectivity in factories and the growing usage of servers, these interfaces can be connected to a server which receives information from the programmable logic controller directly or indirectly, and the human-machine interface principally consist of a user interface on a computer display.

It is also common to find a manufacturing execution system hosted on a server possibly outside of the manufacturing premise and sometimes on a distributed system. The manufacturing execution server is responsible for collecting cycle data from programmable logic controllers and sending data to these controllers in order to orchestrate manufacturing and coordinate material flow and other systems.

Other devices and systems such as, for example, smart cameras used for quality control or presence sensors are conventionally discrete from, but directly connected to, a programmable logic controller. Such increase in the number of connected devices and systems in factories has led to a growing traffic over the network infrastructure, and more complexity to manage connections. One critical aspect of managing these connections is to ensure that the network capacities in the factory are aligned with the bandwidth requirements to transfer data in an adequate timely manner, so that the numerous devices and components can act under the time allowed. This is particularly true for safety and shutoff devices and components, which must act and react in short periods of time varying from microseconds to a few milliseconds. The type of connections—wherever they should be analog or digital, can be selected appropriately to optimize the performance of communications between components.

Modern programmable logic controllers typically support multiple types of connections to facilitate the fulfilling of these connectivity requirements. For instance, multiple analog ports are available as communication extensions that can be connected to the core unit of the controller. The core controller uses a proprietary protocol such as EthernetIP, Profinet or EtherCAT developed by Allen-Bradley, Siemens and Beckhoff, respectively, to connect with most automation devices such as actuators, motors, sensors and robots. Also, since the early 2000's most programmable logic controllers have been equipped with at least one Ethernet port which allows them to communicate with the enterprise's network.

Determinism is a key requirement in the selection of the language used to program the controllers that interface with multiple devices critical to the execution and safety of manufacturing equipment. High-level interpreted languages such as Python and javascript are appealing to quickly develop complex programs. However, such languages cannot offer the assurance that code execution will consistently be insured with a predictable timing. They may be suitable to the development of user interfaces, part of the human-machine interfaces for a manufacturing automation system but should not be used to develop the logic that will orchestrate and/or interface with equipment and automation devices.

Telemetry is another key requirement for automation controls. To monitor the status of processes and equipment, data originated from devices, processes and systems will ideally be captured and made available to allow for the analysis of such data. Benefits of making such data available include the ability to troubleshoot and diagnose as well as to better understand the behavior of equipment and systems to increase efficiency, quality and minimize failures.

To produce more efficient, cost effective and evolutive automation controls systems the present invention provides a graphical user interface that simplifies the tasks of creating the programs that run on an automation controller, humane-machine interface system, or a manufacturing execution system.

### DESCRIPTION OF THE INVENTION

In some embodiments, the present invention comprises an integrated development environment including a graphical user interface that is used via one or more user input devices such as a mouse, a keyboard, a voice input device, a touch input device for receiving a gesture from a user, a motion input device for detecting non-touch gestures and other motions by a user, and the like. Output devices such as a graphical display, speakers, printer, haptic devices, and other types of output devices may also be included in the user interface.

The user interface is executed by an embedded computer that possesses one or multiple connectors to control and read from automation controls devices such as motors, sensors, stack lights, scanners, etc. In some embodiments, the graphical user interface is executed on Windows and has been developed for Microsoft Visual Studio, using the C #(C-Sharp) language. However, it is appreciated and understood that the graphical user interface described in the current invention can be adapted to use other languages such as C++, Visual Basic, and the like and can also be modified to work on other operating systems such as Linux. In some embodiments, the present invention comprises an extension or addition (or set of extensions or additions, sometimes referred to as plugins) to an integrated development environment or, in some embodiments, may comprise a standalone integrated development environment, in each case exposing a graphical user interface.

FIGS. 1-3 highlight some typical components and interfaces of an integrated development environment in accordance with the present invention. As noted, in some embodiments, one or more extensions, sometimes referred to as plugins, are provided and added to the development environment. These extensions add visual and programmatic capabilities to allow the creation and modification of automation applications without writing nor editing code. Instead, visual components are manipulated in the user interface, preferably using the integrated development environment's user interface designer tool. Properties and events associated with each component allow for the description of its configuration and behavior which includes but is not limited to default values, interaction with other local or remote components, and the like.

Although graphically oriented programming tools are known in the art, such tools create a canvas to help the user of a program create a skeleton for the application or system, but ultimately requires the user to have programming or developer knowledge sufficient to write code to fill in the required functionality between the system's components. The present invention, on the other hand, exposes programmatic components to the integrated development environment that are a digital representation of physical devices or components, such as buttons, scanners, motors, lights, etc. Properties of each component are made available to the integrated development environment allowing for the configuration and setup of attributes through the same “properties interface” exposed with other default properties inherited from the development environment for the target project. The default properties specific to the components are augmented with properties specific to the added components and are available in the same location of the user interface where default properties are accessible. Some properties are added to the programmatic components and automatically exposed to the user interface for the target project by the integrated development environment, while others may require an extension to the integrated development environment that will augment the user interface so that such properties are exposed to the user when components containing the related properties are included in the target project.

The graphical user interface is configured to expose and utilize functions and actions in addition to properties and events. In the case of events, a user using the integrated development environment is by default able to automate the generation of the code for an empty function that would be called when such an event is populated—sometimes referred to as an event handler. In a conventional setting, a developer is needed to edit the event handler by writing code to fill the body of the function to implement the logic that will drive the behavior of the component when such an event is received. In the case of interaction between a component and another component of the project, the developer writing code will need to know the identification of the other component and how to use the interface that allows for the programming of the behavior of such components. The present invention, however, automatically generates the code that handles all the possible commands and actions for all components added to the project, so that there is one function per command or actions added to the code of the currently edited source file.

In the example where the automation component added to the user interface is the representation of an electric motor and, more particularly, a variable frequency drive, the extension is employed as a user interface that will expose default properties for the electric motor such as the default action (stop, run forward, run backward) and velocity as well as which ports or addresses are used to communicate with the motor. In addition, events generated by the motor components are exposed. Some are default as previously described while some others are specific to the motor drive. For instance, the change of state or change of speed for the motor are possible events that can be captured and utilized by the program.

In a conventional setting, the default interface would not allow for exposing the possible functional commands for a component. For instance, if one wants to start a motor when an event occurs, one will typically need to create a function that would be properly formatted with appropriate attributes such as the right type and number of parameters and the right type of return value and fill this function by writing code that will refer to the motor and call one or more methods or functions to pass the appropriate information to the motor. This would require a programmer to have functional knowledge of the programming language and the interfaces that would command the motor. Conversely, the present invention generates such functions, including the code needed in the body of these functions, so that all actions and commands possible for a component are directly available in the user interface of the integrated development environment. As a result, users can simply refer to a command as a response to an event. For instance, if one desires to start a motor when another motor stops, the function to start the desired motor can be found in the list of functions that can be called as a response to the desired event for the motor that will generate such an event. The present invention is also enabled to select multiple event handlers for one event, whereas conventional integrated development environments expose a user interface that allows the selection of only one event handler.

Actual business processes such as manufacturing automation require multiple components to interact with each other simultaneously. For instance, the detection of a part can trigger the starting of one or multiple motors for a conveyance and initiate one of several software procedures to be performed. A difficulty in the field of automation and particularly manufacturing is the gathering of data specific to components and devices responsible for executing processes. These processes can be purely software, for instance the recording of data in a database, or hardware such as the state and speed of rotation of a motor, the values of electric currents and voltages, etc. Tasks initiated by human operators also lead to events and data that can be recorded, for instance the bolting of a screw can be done using a tool that records the torque values. As a result, tasks either initiated by human actions or automatically executed by the automation program generate data that is worth recording for multiple reasons including diagnostics, observability but also to characterize the behavior of these components to enable the detection of failure, the modeling of failure modes, and the like. Each series of data points for a given component constitute a signal frequently worth representing as a curve over time to facilitate the interpretation of such data by humans. Accordingly, the present invention is configured to systematically gather data for the components instantiated in the development environment. In addition, the pipeline necessary to aggregate the data and send it to a centralized or distributed dispatch system is generated automatically. For each component, the controller on which the component runs—or to which it is connected to, opens a communication channel with a server or distributed system, specific to the given component. The channel is named after the component itself so that clients subscribing to the data can more easily identify the source of the signal. In addition, the data server associated with the present invention automatically generates the interface that allows the displaying of the signals received from the controllers.

Each time an automation component is added to the project, functions mapping to commands relevant to the components are automatically generated so they can be instantiated from the user interface of the integrated development environment. This enables the development of complex logic and interaction without editing code, resulting in faster bring-up and development time with much lower skills required for the user. The user interface exposed by the integrated development environment of the present invention is also improved so that multiple event handlers can be selected in response to one same event. During the runtime, signals from all the components are gathered and automatically broadcasted, resulting in automatic telemetry without having to write code. This results in delivering a complete telemetry pipeline entirely automatically as highlighted in FIG. 4.

The integrated development environment in accordance with the present invention can be used to design, implement, and develop both the user interface and the logic of programs that can execute the process for an automated workflow, without having to write or edit any code.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

FIG. 1 is snippet of a graphical user interface pertaining to a part presence sensor, the graphical user interface enabled by the present invention.

FIG. 2 is a snippet of a graphical user interface pertaining to a hand scanner, the graphical user interface enabled by the present invention.

FIG. 3 is another snippet of a graphical user interface after the project has been compiled on a custom controller, the graphical user interface enabled by the present invention.

FIG. 4 is a schematic of the data gathering system and related telemetry control.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### BEST MODE FOR CARRYING OUT THE INVENTION

The present invention provides its benefits across a broad spectrum of endeavors. It is applicant's intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The exemplary method of operating the system is described in detail according to the preferred embodiment, without attempting to describe all the various forms and modifications in which the invention might be embodied. As such, the embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, subparagraph (f).

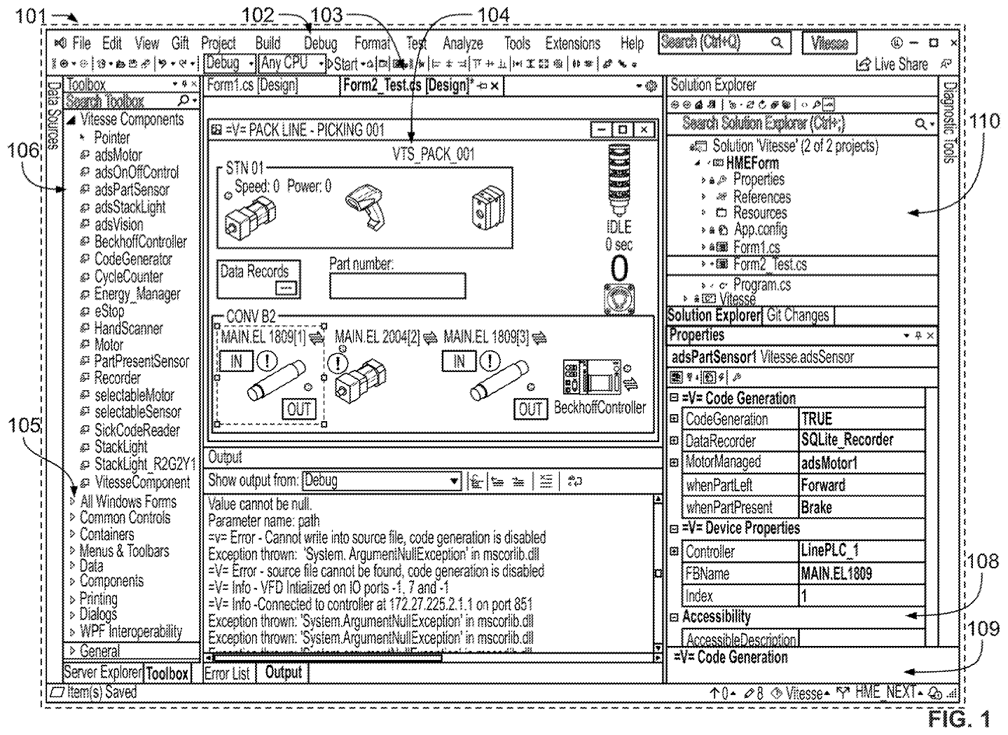

FIG. 1 depicts the typical components and interfaces of an integrated development environment comprising a graphical user interface in accordance with the present invention. The environment is prepared for exemplary purposes only in Visual Studio, developed by Microsoft. The integrated development environment has been augmented by the addition of the present invention, which in some embodiments, comprises an extension (addition or plugin) which enables the user interface. The main window (101) contains all the interfaces and tools needed for the user to design, develop, compile, release, debug and deploy software programs and libraries. The interface comprises a menu bar (102), a quick toolbar (103) that gives access to the most used tools, a designer window (104) in which the user can create and arrange user interfaces using the graphical interface. A primary panel (105) containing a list of components available to be inserted in the interface, arranged under categories of components, allows the user to select components to be inserted in the interface being designed in the designer window (104). A secondary panel (106) exposes one or more of the automation components that have been added to the integrated development environment by the present invention. They have been instantiated in the interface designer window (104) which contains, for exemplary purposes, visual elements corresponding to various automation controls components including a manual barcode scanner, an electric motor, one or more part presence sensors, an emergency stop button, and an instance of a programmable logic controller (PLC) (identified as a BeckhoffController, for exemplary purposes). A property panel (108) displays the properties available for the item selected in the designer window (104). A contextual information panel (109) can display information to help the user understand the currently selected property. A navigation panel (110) allows for a quick access to all the files and resources included in the current project or solution.

More specifically, FIG. 1 shows the properties for a part presence sensor that is selected in the graphical user interface. The property panel (108) highlights options related to code generation, such as which motor can be started and stopped automatically when this sensor has detected that a part arrived or left. In some embodiments, the physical device for this part sensor is connected to a PLC. The property panel (108) shows which PLC hosts this sensor, on which I/O block and port. The user interface also indicates that all events of interest for this part presence sensor should be stored in a database as described in the “DataRecorder” field. The list of available functions also known as event handlers contains the automatically generated functions for the selected component. Using such an implementation, the user can create a process without writing any code.

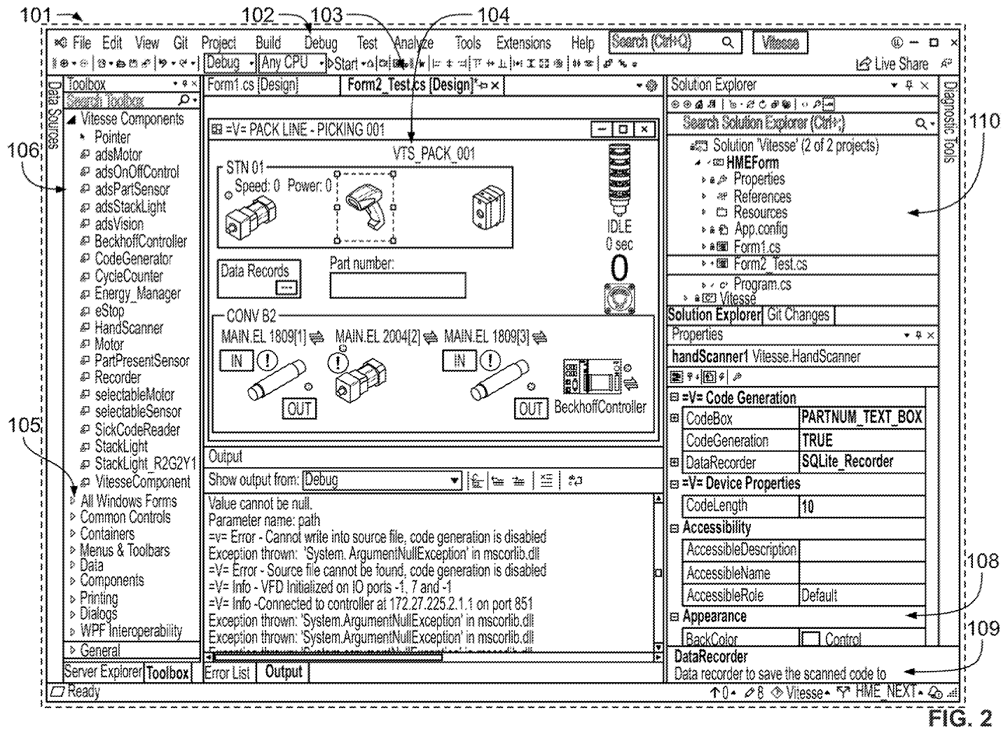

FIG. 2 shows, for exemplary purposes, the options for a hand scanner that is connected to an industrial computer. The property panel (108) highlights that the code scanned will be displayed in the text edit box ‘PARTNUM_TEXT_BOX’. It also shows that the code scanned is to be stored into a local SQL database. In some embodiments, one component on the right of the user interface shows the current state and cycle time for the process at this station, and how many cycles have been executed. This is automatically generated once the user defines what components in the interface create events that will trigger the process to start and end. This allows for a tracking of cycle times as well as how many cycles are performed without having to program.

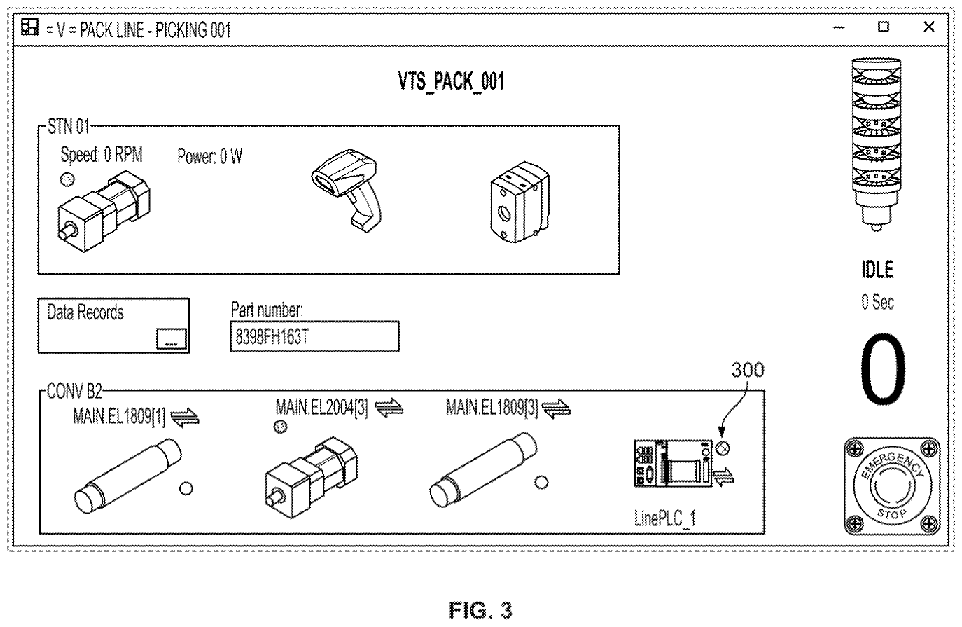

FIG. 3 is a screenshot of the project shown in FIGS. 1 and 2 once it has been compiled and deployed on a custom PLC. The LED (300) on the instance of the PLC highlights that the connection is established and the EtherCAT components in the CONV B2 group are online. In this manner, the user interface can control and generate code for a combination of local and remote devices, seamlessly.

In some embodiments, the integrated development environment (or extension, addition, or plugin thereto) includes a source code generation module that is configured to generate source code to expose commands for automation controls components through functions that are usable as event handlers. Through the graphical user interface, visual components can be added to the integrated development environment, which visual components represent physical and logical components and systems to be interfaced with other components, and which are linked to the source code generation module. The source code generator is configured to automatically generate source code corresponding to each component. The integrated development environment enables modification of the component interfaces so that each event can be enabled to handle a plurality of event handlers without having to write or edit any source code pertaining thereto. In some embodiments, the instantiation of a component into a project using the integrated development environment automates the generation of the source code that captures and broadcasts signals from the component to a communication channel that is declared on demand, resulting in automated telemetry originating from the component (or PLC connected thereto) during runtime. In some embodiments, a web application automatically creates the graphs or tables to represent the telemetry data for each signal received from the controller, as further described below.

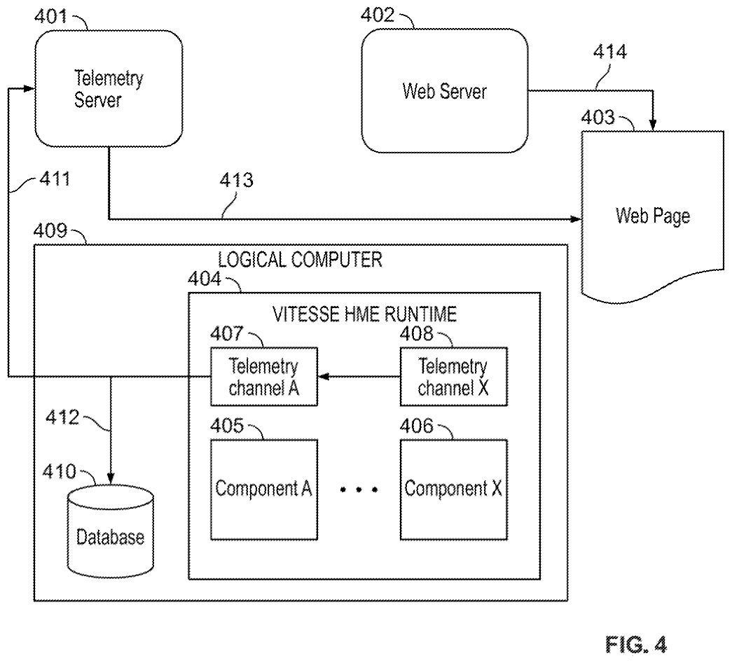

FIG. 4 is a schematic of the data infrastructure implementation for the current embodiment of the present invention. A human-machine execution runtime (404) running on a physical or virtualized computer (409) contains multiple instances of automation components illustrated here with the beginning and end of the list of these components (405) to (406). For each of these components the runtime (404) instantiates a communication channel, respectively from (407) to (408). All these channels post data to a communication pipeline (411) onto the telemetry server (401). A web server (402) hosts a web application that includes code that will dynamically process and output charts and tables when a web page (403) executes the program. The web page (403) consumes data from the telemetry server (401) through a data pipeline (413) to display the data. In some embodiments, web sockets are used to exchange data between the human-machine execution runtime (404) and the telemetry server (401) as well as between the telemetry server and the web page (403).

The described integrated development environment (or extension, addition, or plugin thereto) can be implemented within a single processing device but can also be distributed across multiple processing devices or sub-systems that cooperate in executing program instructions. Examples of processing system include general purpose central processing units, application specific processors, and logic devices, as well as any other type of processing device, combinations of processing devices, or variations thereof. Storage system can comprise any storage media readable by processing system, and capable of storing software. Storage system can include volatile and nonvolatile, removable and non-removable media implemented in any method or technology for storage of information, such as computer readable instructions, data structures, program modules, or other data. Storage system can be implemented as a single storage device but may also be implemented across multiple storage devices or sub-systems. Storage system can comprise additional elements, such as a controller, capable of communicating with the system. Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only the claims and equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. An integrated development environment, comprising:
graphical user interface displaying one or more visual elements corresponding to an automation controls component; and
a source code generation module configured to automatically generate source code to expose commands for the automation controls component through functions usable as event handlers.

2. The integrated development environment of claim 1, enabling modification of an interface associated with the automation controls component to enable handling of a plurality of the event handlers without having to write or edit source code pertaining thereto.

3. The integrated development environment of claim 1, wherein the graphical user interface enables the addition, removal, or modification of the visual elements corresponding to the automation controls component.

4. The integrated development environment of claim 1, wherein instantiation of the automation controls component into a project automatically generates source code that captures and broadcasts signals from the automation controls component to a communication channel enabling automated telemetry originating from the automation controls component.

5. The integrated development environment of claim 4, including a web application configured to automatically create visual representations of telemetry data for each signal, the telemetry data associated with the telemetry originating from the automation controls component.

6. The integrated development environment of claim 5, wherein the signals are received from a programmable logic controller associated with the automation controls component.

7. The integrated development environment of claim 5, wherein the web application is hosted by a web server in communication with a telemetry server, the telemetry server capturing and broadcasting the signals.

8. A plugin for an integrated development environment, comprising:
graphical user interface displaying one or more visual elements corresponding to an automation controls component; and
a source code generation module configured to automatically generate source code to expose commands for the automation controls component through functions usable as event handlers.

9. The plugin of claim 8, enabling modification of an interface associated with the automation controls component to enable handling of a plurality of the event handlers without having to write or edit source code pertaining thereto.

10. The plugin of claim 8, wherein the graphical user interface enables the addition, removal, or modification of the visual elements corresponding to the automation controls component.

11. The plugin of claim 8, wherein instantiation of the automation controls component into a project automatically generates source code that captures and broadcasts signals from the automation controls component to a communication channel enabling automated telemetry originating from the automation controls component.

12. The plugin of claim 11, including a web application configured to automatically create visual representations of telemetry data for each signal, the telemetry data associated with the telemetry originating from the automation controls component.

13. The plugin of claim 12, wherein the signals are received from a programmable logic controller associated with the automation controls component.

14. The plugin of claim 12, wherein the web application is hosted by a web server in communication with a telemetry server, the telemetry server capturing and broadcasting the signals.

15. A method of programming an automation controls component, comprising:
a. providing an integrated development environment comprising (i) a graphical user interface and (ii) a source code generation module;
b. adding, through the graphical user interface, one or more visual elements corresponding to an automation controls component;
c. automatically generating source code to expose commands for the automation controls component through functions usable as event handlers;
d. modifying an interface associated with the automation controls component to enable handling of a plurality of the event handlers without having to write or edit source code pertaining thereto;
e. automatically generating source code that captures and broadcasts signals from the automation controls component to a communication channel enabling automated telemetry originating from the automation controls component; and
f. creating visual representations of telemetry data for each signal, the telemetry data associated with the telemetry originating from the automation controls component.
